(19) United States
(12) Patent Application Publication
(10) Pub. No.: US 2022/0163911 A1
(43) Pub. Date: May 26, 2022

(54) FIXING DEVICE AND IMAGE FORMING APPARATUS

(71) Applicant: KYOCERA Document Solutions Inc., Osaka (JP)

(72) Inventors: Shoko Gon, Osaka-shi (JP); Kenichi Kasama, Osaka-shi (JP)

(73) Assignee: KYOCERA Document Solutions Inc., Osaka (JP)

(21) Appl. No.: 17/456,017

(22) Filed: Nov. 22, 2021

(30) Foreign Application Priority Data
Nov. 25, 2020 (JP) 2020-195218

(51) Int. Cl. G03G 15/20

(52) U.S. Cl. CPC G03G 15/2053

(57) ABSTRACT

A fixing device includes a pair of rotating members and a heating part. The pair of rotating members holds a recording medium, passes the recording medium and thermally fixes toner on the recording medium. The heating part heats one rotating member of the pair of rotating members to increases a temperature of the rotating member. The heating part is PID or PI controlled. When power consumption of an apparatus including the pair of rotating members is not higher than a predetermined value, a PID coefficient or a PI coefficient used in the PID control or the PI control is set to be smaller than when the power consumption is higher than the predetermined value.

### INCORPORATION BY REFERENCE

This application is based on and claims the benefit of priority from Japanese patent application No. 2020-195218 filed on Nov. 25, 2020, which is incorporated by reference in its entirety.

### BACKGROUND

The present disclosure relates to a fixing device and an image forming apparatus.

An electrophotographic type forming apparatus such as a printer and a copying machine forms an image on a recording medium such as a paper sheet based on image data. The image data is generated by reading a document placed on a document table by the image forming apparatus. In the electrophotographic type image forming apparatus, a heating roller and a pressing roller of a fixing device of the image forming apparatus presses and heats the recording medium to fix an unfixed toner image on the recording medium.

As a method for controlling the heating of the fixing device to adjust a temperature of the heating roller, PID control is proposed. For example, a fixing heater control device executes PID control at a time of image forming operation and executes hysteresis control at a time of standby.

When the PID control is executed, if the PID coefficient in the arithmetic expression used for the PID control is not properly set, temperature ripple increases and proper temperature control cannot be performed.

### SUMMARY

In accordance with an aspect of the present disclosure, a fixing device includes a pair of rotating members and a heating part. The pair of rotating members holds a recording medium, passes the recording medium and thermally fixes toner on the recording medium. The heating part heats one rotating member of the pair of rotating members to increases a temperature of the rotating member. The heating part is PID or PI controlled. When power consumption of an apparatus including the pair of rotating members is not higher than a predetermined value, a PID coefficient or a PI coefficient used in the PID control or the PI control is set to be smaller than when the power consumption is higher than the predetermined value.

In accordance with an aspect of the present disclosure, an image forming apparatus includes the fixing device and a controller which PID or PI controls the fixing device.

The other features and advantages of the present disclosure will become more apparent from the following description. In the detailed description, reference is made to the accompanying drawings, and preferred embodiments of the present disclosure are shown by way of example in the accompanying drawings.

### BRIEF DESCRIPTION OF THE DRAWINGS

FIG. 1 is a view showing an example of a configuration of an image forming apparatus 1.

FIG. 2 is a view showing a fixing device 8 according to the embodiment of the present disclosure.

FIG. 3A is a diagram showing PID control of an induction heating part 83.

FIG. 3B is a diagram showing the PID control of the induction heating part 83.

FIG. 4 is a diagram showing power consumption and input power for state (mode) of the image forming apparatus 1.

FIG. 5 is a table showing a PID control result when PID coefficient is set to correspond to the power consumption of the image forming apparatus 1.

### DETAILED DESCRIPTION

Hereinafter, with reference to the attached drawings, one embodiment of the present disclosure will be described. In the drawings, the same or corresponding parts are designated by the same reference numerals, and description thereof is not repeated.

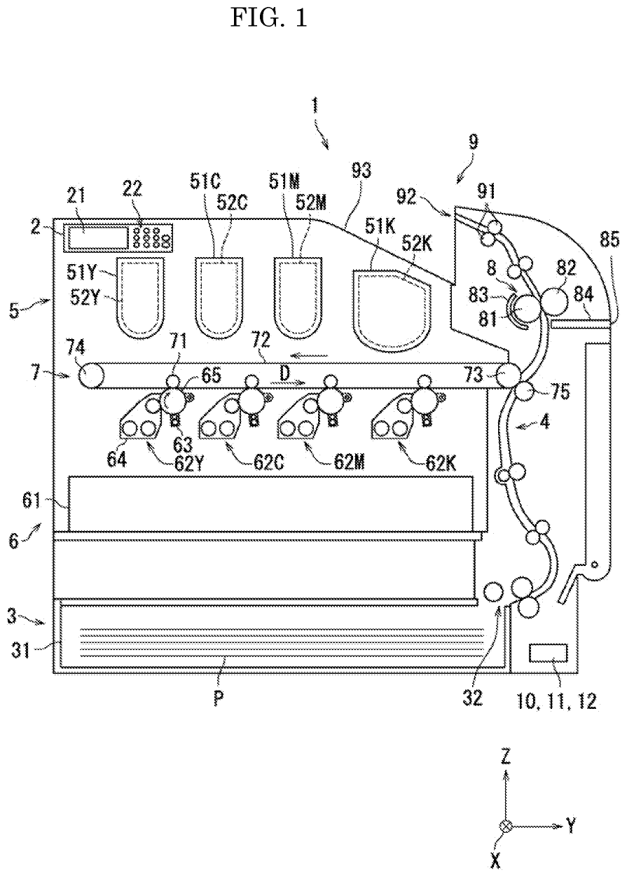

With reference to FIG. 1, a configuration of an image forming apparatus 1 according to the embodiment of the present disclosure will be described. FIG. 1 is a view showing the configuration of the image forming apparatus 1. The image forming apparatus is a tandem type color printer, for example.

As shown in FIG. 1, the image forming apparatus 1 includes an operation part 2, a sheet feeding part 3, a conveyance part 4, a toner replenishment part 5, an image forming part 6, a transfer part 7, a fixing device 8, a discharge part 9 and a controller 10.

The operation part 2 receives an instruction from a user. When the instruction is received, the operation part 2 transmits a signal showing the instruction from the user to the controller 10. The operation part 2 includes a liquid crystal display 21 and a plurality of operation keys 22. The liquid crystal display 21 displays various processing results, for example. The operation key 22 includes a ten key and a start key, for example. When the instruction showing performing an image forming operation is input, the operation part 2 transmits a signal showing the performing of the image forming operation to the controller 10. As a result, the image forming operation by the image forming apparatus 1 is started.

The sheet feeding part 3 includes a sheet feeding cassette 31 and sheet feeding rollers 32. The sheet feeding cassette 31 can store a plurality of sheets P. The sheet feeding rollers 32 feed the sheet P stored in the sheet feeding cassette 32 to the conveyance part 4 one by one. The sheet P is an example of a recording medium.

The conveyance part 20 includes a roller and a guide member. The conveyance part 4 extends from the sheet feeding part 3 to the discharge part 9. The conveyance part 4 conveys the sheet P from the sheet feeding part 3 to the discharge part 9 through the image forming part 6 and the fixing device 8.

The toner replenishment part 5 replenishes toner to the image forming part 6. The toner replenishment part 5 includes a first attachment part 51Y, a second attachment part 51C, a third attachment part 51M and a fourth attachment part 51K. The toner replenishment part 5 is an example of a developer replenishment part. The toner is an example of a developer.

A first toner container 52Y is attached to the first attachment part 51Y. In the same manner, a second toner container 52C, a third toner container 52M and a fourth toner container 52K are attached to the second attachment part 52C, the third attachment part 52M and the fourth attachment part 52K, respectively. The first attachment part 51Y to the fourth attachment part 51K have the same configuration except a type of the toner container to be attached is different from each other. Then, the first attachment part 51Y to the fourth attachment part 51K are sometimes referred to as the “attachment part 51”.

Toners are stored in the first toner container 52Y, the second toner container 52C, the third toner container 52M, and the fourth toner container 52K. In this embodiment, the yellow toner is stored in the first toner container 52Y. The cyan toner is stored in the second toner container 52C. The magenta toner is stored in the third toner container 52M. The black toner is stored in the fourth toner container 52K.

The image forming part 6 includes an exposure device 61, a first image forming unit 62Y, a second image forming unit 62C, a third image forming unit 62M, and a fourth image forming unit 62K.

Each of the first image forming unit 62Y to the fourth image forming unit 62K has a charging device 63, a development device 64, and a photosensitive drum 65. The photosensitive drum 65 is an example of an image carrier.

The charging device 63 and the development device 64 are disposed around the circumferential surface of the photosensitive drum 65. In this embodiment, the photosensitive drum 65 rotates in the direction indicated by the arrow in FIG. 1 (clockwise direction).

The charging device 63 uniformly charges the photosensitive drum 65 to a predetermined polarity by discharge. In this embodiment, the charging device 63 charges the photosensitive drum 65 to a positive polarity. The exposure device 61 irradiates the charged photosensitive drum 65 with a laser beam. Thus, an electrostatic latent image is formed on the surface of the photosensitive drum 65.

The development device 64 develops the electrostatic latent image formed on the surface of the photosensitive drum 65 to form a toner image. The development device 64 is replenished with the toner from the toner replenishment part 5. The development device 64 supplies the toner replenished from the toner replenishment part 5 to the surface of the photosensitive drum 65. As a result, a toner image is formed on the surface of the photosensitive drum 65.

In this embodiment, the development device 64 in the first image forming unit 62Y is connected to the first attachment part 51Y. Therefore, the yellow toner is supplied to the development device 64 in the first image forming unit 62Y. Thus, the yellow toner image is formed on the surface of the photosensitive drum 65 in the first image forming unit 62Y.

The development device 64 in the second image forming unit 62C is connected to the second attachment part 51C. Therefore, the cyan toner is supplied to the development device 64 in the second image forming unit 62C. Thus, the cyan toner image is formed on the surface of the photosensitive drum 65 in the second image forming unit 62C.

The development device 64 in the third image forming unit 62M is connected to the third attachment part 51M. Therefore, the magenta toner is supplied to the development device 64 in the third image forming unit 62M. Thus, the magenta toner image is formed on the surface of the photosensitive drum 65 in the third image forming unit 62M.

The development device 64 in the fourth image forming unit 62K is connected to the fourth attachment part 51K. Therefore, the black toner is supplied to the development device 64 in the fourth image forming unit 62K. Thus, the black toner image is formed on the surface of the photosensitive drum 65 in the fourth image forming unit 62K.

The transfer part 7 transfers and layers the toner images formed on the surfaces of the photosensitive drums 65 of the first image forming unit 62Y to the fourth image forming unit 62K on the sheet P. In the present embodiment, the transfer part 7 transfers and layers the toner images on the sheet P in a secondary transfer manner. In detail, the transfer part 7 includes four primary transfer rollers 71, an intermediate transfer belt 72, a drive roller 73, a driven roller 74 and a secondary transfer roller 75.

The intermediate transfer belt 72 is an endless belt stretched around the four primary transfer rollers 71, the drive roller 73, and the driven roller 74. The intermediate transfer belt 72 is driven according to the rotating of the drive roller 73. In FIG. 1, the intermediate transfer belt 72 travels in the counterclockwise direction. The driven roller 74 is rotationally driven in accordance with the traveling of the intermediate transfer belt 72.

The first image forming unit 62Y to the fourth image forming unit 62K are disposed along the traveling direction D of the lower surface of the intermediate transfer belt 72 so as to face the lower surface of the intermediate transfer belt 72. In this embodiment, the first image forming unit 62Y to the fourth image forming unit 62K are disposed in the order of the first image forming unit 62Y to the fourth image forming unit 62K from the upstream side to the downstream side of the lower surface of the intermediate transfer belt 72 in the traveling direction D.

Each primary transfer roller 71 is disposed so as to face each photosensitive drum 65 via the intermediate transfer belt 72, and pressed toward each photosensitive drum 65. Therefore, the toner images formed on the surfaces of the photoreceptor drums 65 are sequentially transferred to the intermediate transfer belt 72. In this embodiment, the yellow toner image, the cyan toner image, the magenta toner image, and the black toner image are layered and transferred to the intermediate transfer belt 72 in this order. Hereinafter, the toner image in which the yellow toner image, the cyan toner image, the magenta toner image, and the black toner image are layered may be referred to as a “layered toner image”.

The secondary transfer roller 75 is disposed opposite to the drive roller 73 via the intermediate transfer belt 72. The secondary transfer roller 75 is pressed toward the drive roller 73. Thus, a transfer nip is formed between the secondary transfer roller 75 and the drive roller 73. When the sheet P passes through the transfer nip, the layered toner image on the intermediate transfer belt 72 is transferred to the sheet P. In this embodiment, the yellow toner image, the cyan toner image, the magenta toner image, and the black toner image are transferred in this order from the upper layer to the lower layer on the sheet P. The sheet P on which the layered toner image is transferred is conveyed to the fixing device 8 by the conveyance part 4.

The fixing device 8 holds the sheet P and thermally fixes the toner to the sheet P. Specifically, the fixing device 8 includes a heating roller 81 and a pressing roller 82 which are an example of a pair of rotating members. The fixing device 8 fixes the unfixed layered toner image transferred to the sheet P to the sheet S in the transfer part 7. The heating roller 81 and the pressing roller 82 are arranged so as to face each other to form a fixing nip N. The sheet P conveyed from the image forming part 6 is pressed while being heated at a predetermined fixing temperature by passing through the fixing nip N. As a result, the layered toner image is fixed to the sheet P. The sheet P is conveyed from the fixing device 8 to the discharge part 9 by the conveyance part 4.

The discharge part 9 includes a pair of discharge rollers 91 and a discharge tray 93. The pair of discharge rollers 91 conveys the sheet P to the discharge tray 93 through a discharge port 92. The discharge port 92 is formed on the upper portion of the image forming apparatus 1.

The controller 10 controls the operation of each part of the image forming apparatus 1. The controller 10 includes a processor 11 and a storage 12. The processor 11 includes a central processing unit (CPU), for example. The storage 12 includes a memory such as a semiconductor memory, and may include an HDD (Hard Disk Drive). The storage 12 stores a control program. The processor 11 controls the operation of the image forming apparatus 1 by executing the control program.

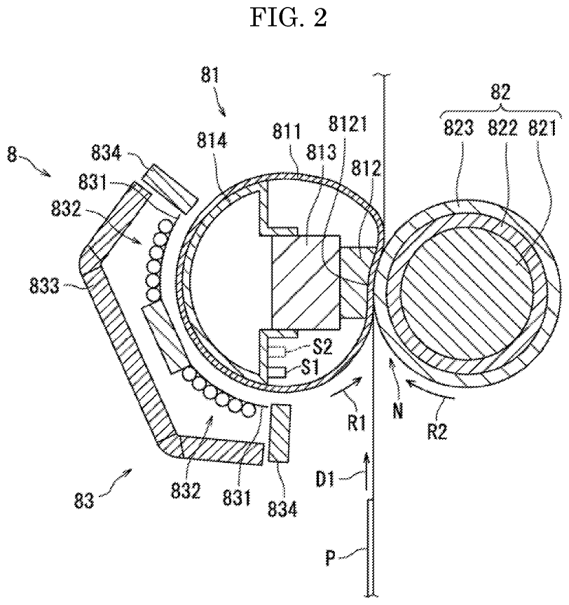

Next, the fixing device 8 according to the embodiment of the present disclosure will be described with reference to FIG. 1 and FIG. 2. FIG. 2 is a view showing the fixing device 8 according to the embodiment of the present disclosure.

As shown in FIG. 2, the fixing device 8 includes the heating roller 81, the pressing roller 82, and an induction heating part 83.

The pressing roller 82 has a core metal 821, an elastic layer 822 and a release layer 823. The pressing roller 82 corresponds to an example of a “rotating member”. The outer diameter of the pressing roller 82 is 30 mm to 35 mm, for example. The elastic layer 822 is formed on the core metal 821. The release layer 823 covers the surface of the elastic layer 822. The core metal 821 is made of stainless steel, for example. The elastic layer 822 is made of silicone rubber having a thickness of about 5 mm, for example. The release layer 823 is made of fluororesin such as PFA (tetrafluoroethylene/perfluoroalkyl vinyl ether copolymer), for example.

The heating roller 81 and the pressing roller 82 heat and presses the sheet P at the fixing nip N, and fix the image formed on the sheet P to the sheet P. The heating roller 81 includes a fixing belt 811, a pressing pad 812, a support member 813, a belt guide member 814, and a temperature sensor S1.

For example, the fixing belt 811 is an endless belt formed in a cylindrical shape having an outer diameter of 30 mm, and has an induction heating layer containing a magnetic metal material. In the fixing belt 811, a silicone rubber layer having a thickness of about 200 μm to 500 μm is laminated on a nickel electroformed substrate having a thickness of 30 μm to 50 μm. The surface of the silicone rubber layer outside the fixing belt 811 is covered with a release layer made of fluororesin such as PFA. The surface of the silicone rubber layer inside the fixing belt 811 is covered with heat-resistant resin coat such as PTFE (polytetrafluoroethylene).

The induction heating layer of the fixing belt 811 generates heat by a change in a magnetic field generated by the induction heating part 83. When the pressing roller 82 rotates in the rotational direction R1 (in the counterclockwise direction), the fixing belt 811 is followed to be rotated in the rotational direction R2 (in the clockwise direction). That is, the pressing roller 82 comes into contact with the outer circumferential surface of the fixing belt 811 and rotates the fixing belt 811.

The pressing pad 812 presses the fixing belt 811 against the pressing roller 82. The pressing pad 812 is fixed to the support member 813 inside the fixing belt 811, and faces the pressing roller 82 via the fixing belt 811. The pressing pad 812 is made of heat-resistant resin such as liquid crystal polymer (LCP), for example. The pressing pad 812 has a sliding surface 8121. The sliding surface 8121 slides to the fixing belt 811. Silicone oil is applied to the sliding surface 8121.

The support member 813 is fixed to the inside of the fixing belt 811. The support member 813 is preferably made of nonmagnetic material so as not to be heated by the induction heating part 83. The support member 813 is made of iron-based alloy, for example.

The belt guide member 814 is fixed to the support member 813 inside the fixing belt 811, and faces the induction heating part 83 via the fixing belt 811.

The belt guide member 814 supports the inner circumferential surface of the fixing belt 811 to stabilize the traveling track of the fixing belt 811. The belt guide member 814 applies predetermined tension to the fixing belt 811. The belt guide member 814 is preferably made of magnetic metal material so as to be heated by the induction heating part 83. The belt guide member 814 is made of iron-based alloy (for example, SUS) having a thickness of about 0.2 mm to 0.3 mm., for example.

The temperature sensor S1 detects a temperature TH of the fixing belt 811. The temperature sensor S1 is fixed at a position near the fixing belt 811 in the belt guide member 814, for example. As the temperature sensor S1, a thermistor is used, for example. A detection signal of the temperature sensor S1 is transmitted to the controller 10.

The heating roller 81 may be further provided with a humidity sensor S2. The humidity sensor S2 detects a humidity HU of a portion near the fixing belt 811. The humidity sensor S2 is fixed to a position near the fixing belt 811 in the belt guide member 814. As the humidity sensor S2, a variable resistance humidity sensor is used, for example. A detection signal of the humidity sensor S2 is transmitted to the controller 10. In the following description, a case where the heating roller 81 is not provided with the humidity sensor S2 will be described.

The induction heating part 83 heats the fixing belt in a so-called IH (Induction Heating) manner. The induction heating part 83 includes a coil bobbin 831, a coil 832, an arched core 833 and a pair of side cores 834. The induction heating part 83 is an example of a “heating part”.

The coil bobbin 831 is disposed with a predetermined distance from the outer circumferential surface of the fixing belt 811, and faces the belt guide member 814 via the fixing belt 811. The coil bobbin 831 is preferably made of heat-resistant resin.

The coil 832 heats the fixing belt 811 in an induction heating manner. The coil 832 is formed by winding a conducting wire (for example, a litz wire) along an axial direction of the pressing roller 82 for several times. The coil 832 is fixed to the coil bobbin 831.

The arched core 833 and the pair of side cores 834 surround the outside of the coil 832. The arched core 833 extends in an arched shape around the coil bobbin 831. The side cores 834 are disposed near the end portions of the arched core 833. The arched core 833 and the pair of side cores 834 are made of magnetic material, such as ferrite. Therefore, a magnetic flux generated by the coil 832 is introduced by the arched core 833 and the pair of side cores 834 and is formed around the fixing belt 811.

For example, the coil 832 is connected to a power circuit (not shown) and generates an AC magnetic flux (an AC magnetic field) by a high frequency current supplied from the power circuit. The AC magnetic flux produces an eddy current in the induction heat generating layer of the fixing belt 811. When the eddy current is produced in the induction heat generating layer, Joule heat is generated owing to electric resistance of the induction heat generating layer, and heats the fixing belt 811.

At this time, the controller 10 PID controls the induction heating part 83. For example, the controller 10 controls the power circuit such that the temperature TH of the fixing belt 811 is kept at a predetermined temperature for a predetermined period.

Specifically, the controller 10 calculates a power (an operation amount) required for keeping the temperature TH of the fixing belt 811 at the predetermined temperature for the predetermined period, based on PID arithmetic operation shown in the expression (1).

MV_{N}=K_{P}*eₙ+KᵢΣeₙ+K_{d}(eₙ−eₙ₋₁) [Expression 1]

In the expression (1), MV_{N} shows an operation amount. “Kₚ” shows a proportional gain (P gain). “Kᵢ” shows an integration gain (I gain). “K_{d}” shown a differential gain (D gain). The P gain, the I gain and the D gain are called a PID coefficient. The P gain, the I gain and the D gain are preset. “eₙ” shows a deviation, and shows a value obtained by subtracting a current temperature from a target temperature.

The controller 10 performs half-wave control and phase control of the voltage applied to the fixing device 8, and controls the induction heating part 83 such that power corresponding to the calculated operation amount is supplied to the fixing device 8, for example.

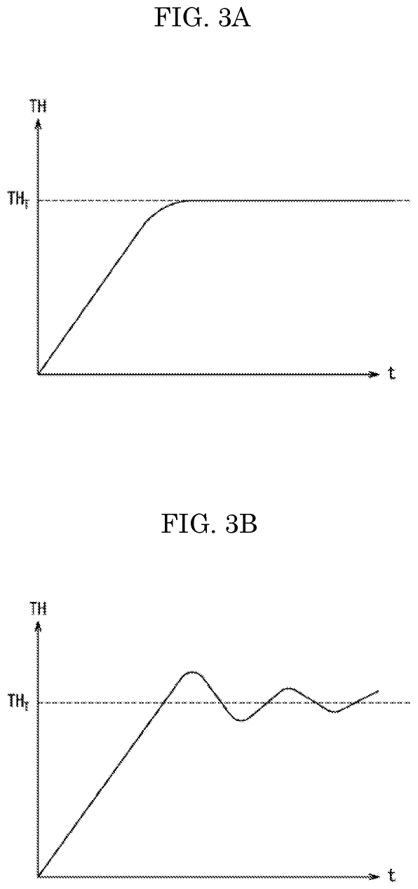

Next, with reference to FIG. 3A and FIG. 3B, the PID control for the induction heating part 83 will be described. FIG. 3A is a diagram showing temperature control in a case where an appropriate PID coefficient is set in the PID control in the induction heating part 83. FIG. 3B is a diagram showing temperature control in a case where an appropriate PID coefficient is not set in the PID control in the induction heating part 83.

When an appropriate PID coefficient is set, responsiveness and temperature stability balance each other. On the other hand, for example, if the P gain is set too large and too much priority is given to the responsiveness, the temperature ripple becomes large and the temperature stability is deteriorated.

In the PID control for the induction heating part 83, for example, when power consumption of the image forming apparatus 1 including the fixing device 8 is large, such as a time of image forming operation, even if the responsiveness and the temperature stability balance each other, the temperature ripple may become large to deteriorate the temperature stability when the power consumption is small (for example, at a time of standby).

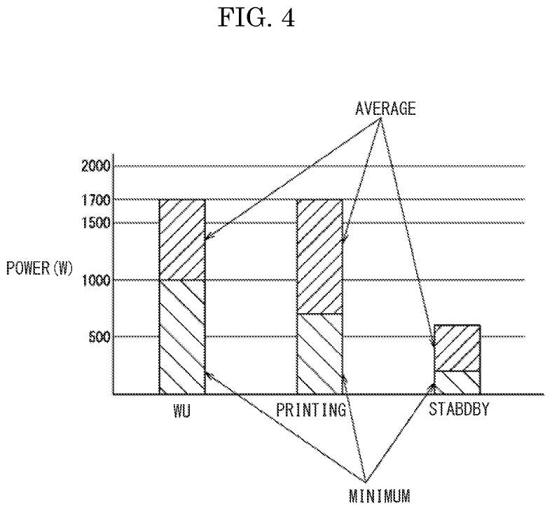

Next, with reference to FIG. 4, the power consumption of the image forming apparatus 1 will be described. FIG. 4 is a diagram showing power consumption and input power for state (mode) of the image forming apparatus 1.

For example, at a time of warm-up (WU) just after the power is input to the image forming apparatus 1, because it is required to increase the temperature TH of the fixing belt 811 quickly, in many cases, the average power consumption may be set to 1000 W to 1700 W (high power consumption). The required power is different depending on a size of the sheet P used in the image forming apparatus 1, a configuration of the fixing device 8, a heat capacity of the fixing device 8, a target temperature, a target power level, and the others. For example, when a warm-up for a short period (a short warm-up) is desired, the input power of about at least 1000 W is required as shown by two types of hatching in FIG. 4.

The temperature TH decreases at a time of image forming operation because the sheet P passes through the fixing device 8, and the power consumption becomes large in order to keep the temperature TH constant. The power consumption of the image forming apparatus 1 is different depending on a conveyance speed of the sheet P, for example, other than the state of the image forming apparatus 1. For example, in a case where a size of the sheet P used in the image forming apparatus 1 is a A4 size and a conveyance speed of the sheet P is 50 to 60 PPM, especially just after the warm-up, because heat storage of the fixing device 8 is insufficient, the average power consumption of 1000 W or larger (high power consumption) is required. When the heat storage of the fixing device 8 becomes sufficient, the required input power is at least 700 W to 800 W.

On the other hand, at a time of standby, there are few factors for lowering the temperature TH, and the power consumption for keeping the temperature TH constant becomes small. For example, even when the heat storage of the fixing device 8 is insufficient, the average power consumption is about 500 W (low power consumption), and when the heat storage of the fixing device 8 is sufficient, the required input power is at least about 200 W or smaller.

For example, if the PID coefficient is set such that the responsiveness and the temperature stability balance each other assuming a time of high power consumption such as a time of WU and a time of the image forming operation and the set PID coefficient is used at a time of low power consumption, overshoot and undershoot are generated and the temperature ripple may become large. This is because in a case of the PID coefficient suitable for temperature control at a time of high power consumption, the responsiveness becomes excessive for the temperature control at a time of low power consumption.

Then, in the present embodiment, depending on the power consumption of the image forming apparatus 1, the setting of the PID coefficient is changed. For example, when the power consumption of the image forming apparatus 1 is not higher than a predetermined value, the PID coefficient is set to be smaller than that in a case where the power consumption is higher than the predetermined value. In the present embodiment, the setting of the PID coefficient is changed by the controller 10.

Specifically, when the power consumption of the image forming apparatus 1 is not higher than 500 W, the controller 10 sets at least one of the P gain, the I gain and the D gain to be smaller than when the power consumption is higher than 500 W. A magnitude of the PID coefficient may be determined by setting the P gain, the I gain and the D gain as one set.

In the embodiment, a boundary between the high power consumption and the low power consumption is set to 500 W, but it is not limited to 500 W, and may be higher or lower than 500 W.

In the embodiment, the controller 10 monitors the power consumption of the image forming apparatus 1 in order to change the setting of the PID coefficient.

For example, the controller 10 obtains output AC voltage (voltage value) and high frequency current (current value) of the power circuit connected to the coil 832 of the induction heating part 83 periodically, and then calculates the power consumption (power value) of the induction heating part 83 based on the obtained voltage value and current value.

The controller 10 calculates an average value (average power consumption) of the plurality of calculated power values during a predetermined period (for example, 1 second), and changes the setting of the PID coefficient based on the calculated average power consumption. The controller 10 may change the setting of the PID coefficient based on the total power consumption of the calculated average power consumption and the power consumption of each part of the image forming apparatus 1.

In this example, the predetermined period is set to 1 second, but it is not limited to 1 second, and it may be a short period such as 0.5 seconds or a period longer than 1 second. However, a shorter period is preferable because a longer period affects the temperature stability.

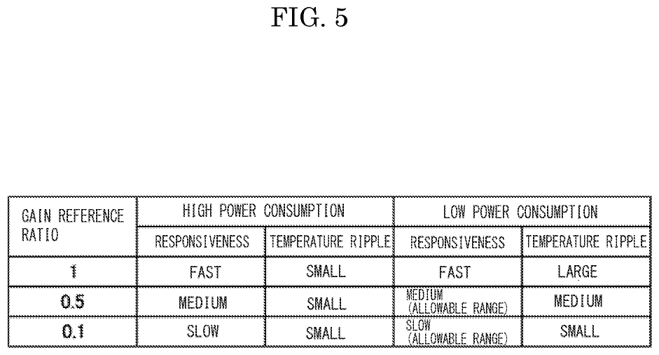

Next, with reference to FIG. 5, the PID control result when the PID coefficient corresponding to the power consumption of the image forming apparatus 1 is set will be described. FIG. 5 is a table showing the PID control result when the PID coefficient corresponding to the power consumption of the image forming apparatus 1 is set.

FIG. 5 shows the responsiveness and the magnitude of temperature ripple at the times of high power consumption and low power consumption when the setting of the PID coefficient is changed with the PID coefficient set to appropriately control the temperature at the time of high power consumption as a reference value (gain reference ratio: 1).

Specifically, when the gain reference ratio is “1”, the responsiveness is fast and the temperature ripple is small at the time of high power consumption. For example, when the temperature TH is 150° C., the temperature ripple is 1° C. to 2° C.

When the gain reference ratio is “1”, the responsiveness is fast but the temperature ripple becomes large at the time of low power consumption. For example, when the temperature TH is 150° C., the temperature ripple is 5° C. or more.

When the setting of the PID coefficient is changed to a half value of the reference value (gain reference ratio: 0.5), the responsiveness becomes slightly slower (“medium”) and the temperature ripple remains small at the time of high power consumption.

When the gain reference ratio is “0.5”, the responsiveness is “medium” and the temperature ripple is 3° C. to 4° C. (“medium”) at the time of low power consumption. It should be noted that the responsiveness “medium” is within the allowable range at the time of low power consumption.

When the setting of the PID coefficient is changed to a value of 10% of the reference value (gain reference ratio: 0.1), the responsiveness becomes slow (“slow”) and the temperature ripple remains small at the time of high power consumption.

When the gain reference ratio is “0.1”, the responsiveness is “slow” and the temperature ripple is small at the time of low power consumption.

From the above results, when the PID coefficient at the time of low power consumption is set so that the gain reference ratio is 0.1 to 0.5, the temperature is appropriately controlled.

In the present embodiment, the induction heating part 83 is PID controlled, but it is not limited to this and may be PI controlled. When the induction heating part 83 is PI controlled, the PI coefficient in the PI control is determined in the same manner as when the induction heating part 83 is PID controlled.

In the present embodiment, the heating part is the induction heating part 83 which heats the fixing belt 811 in the IH manner, but it is not limited to this, and a halogen heater, a resistance heating heater, or the like may be used, for example. In this case, the controller 10 PID controls or PI controls the halogen heater and the resistance heating heater.

In the present embodiment, the fixing device 8 is not limited to that shown in FIG. 2. For example, the fixing device 8 may have one axial belt type or two axial belt type.

Embodiments of the present disclosure have been described above with reference to the drawings (FIG. 1 to FIG. 5). However, the present disclosure is not limited to the embodiments described above, and it is possible to carry out the present disclosure in various embodiments without departing from the gist thereof. Various disclosures can be formed by appropriately combining a plurality of components disclosed in the above embodiments. For example, some of the components may be removed from all of the components shown in the embodiments. In addition, components across different embodiments may be combined as appropriate. In order to facilitate understanding, each component is schematically shown, and the thickness, length, number, gap, and the others of each illustrated component may be different from the actual one for the convenience of drawing. The materials, shapes, dimensions, and the others of the components shown in the above embodiments are not particularly limited, and various modifications can be made without substantially departing from the effects of the present disclosure.

The present disclosure is suitably used for a conveyance device and an image forming apparatus.

1. A fixing device comprising:
a pair of rotating members which holds a recording medium, passes the recording medium and thermally fixes toner on the recording medium; and
a heating part which heats one rotating member of the pair of rotating members to increases a temperature of the rotating member, wherein
the heating part is PID or PI controlled, and
when power consumption of an apparatus including the pair of rotating members is not higher than a predetermined value, a PID coefficient or a PI coefficient used in the PID control or the PI control is set to be smaller than when the power consumption is higher than the predetermined value.

2. The fixing device according to claim 1, wherein
the predetermined value is a high value within a range of the power consumption at a time of standby of the apparatus.

3. The fixing device according to claim 1, wherein
the PID control or the PI control is performed with at least one of the PID coefficients or the PI coefficients, or all of the PID coefficients or the PI coefficients as one set.

4. An image forming apparatus comprising:
the fixing device according to claim 1; and
a controller which PID or PI controls the fixing device.

5. The image forming apparatus according to claim 4, wherein
the controller monitors the power consumption of the image forming apparatus, and
the controller determines the PID coefficient or the PI coefficient based on an average power consumption of the monitored power consumption for a predetermined period.
